(19) United States
(12) Patent Application Publication
(10) Pub. No.: US 2018/0183061 A1
(43) Pub. Date: Jun. 28, 2018

(54) GRAPHITIC MATERIALS AND METHODS OF MAKING SAME

(71) Applicant: 3M INNOVATIVE PROPERTIES COMPANY, St. Paul, MN (US)

(72) Inventors: Mark N. Obrovac, Nova Scotia (CA); Leyi Zhao, Nova Scotia (CA); Xiuyun Zhao, Ontario (CA)

(21) Appl. No.: 15/846,515

(22) Filed: Dec. 19, 2017

Related U.S. Application Data
(60) Provisional application No. 62/438,591, filed on Dec. 23, 2016.

(51) Int. Cl. H01M 4/587; C01B 32/205; H01M 10/0525; H01M 4/133

(52) U.S. Cl. CPC H01M 4/587; C01B 32/205; H01M 10/0525; H01M 4/133; C01P 2004/34; H01M 2004/027; C01P 2006/12; C01P 2006/10; C01P 2002/74; C01P 2004/03; C01P 2006/40

(57) ABSTRACT

A graphitic carbon material includes decorated graphitic spherical shells or fragments of decorated graphitic spherical shells, wherein the decorated graphitic spherical shells or fragments of decorated graphitic spherical shells have an average diameter of between 0.1 and 100 μm.

### FIELD

The present disclosure relates to graphite materials and methods for preparing and using the same.

### BACKGROUND

Various graphites and methods of making graphites are known. Such materials and methods are described, for example, in A. Ōya, H. Marsh, Phenomena of catalytic graphitization, J. Mater. Sci. 17 (1982) 309-322, and Harry Marsh, Edward A. Heintz, Francisco Rodríguez-Reinoso, “Introduction to Carbon Technologies”, Universidad de Alicante, 1997.

### SUMMARY

In some embodiments, a graphitic carbon material includes decorated graphitic spherical shells or fragments of decorated graphitic spherical shells. The decorated graphitic spherical shells or fragments of decorated graphitic spherical shells have an average diameter of between 0.1 and 100 μm.

In some embodiments, a graphitic carbon material includes tessellated regions. The tessellated regions are present in the graphitic carbon material in an amount of between 5 and 100 vol. %, based on the total volume of the graphitic carbon material

In some embodiments, a graphitic carbon material includes random edge arrays that include a random arrangement of graphite platelets or graphite platelet fragments in which platelets are connected by one edge to a common substrate. The graphite platelets or graphite platelet fragments comprising the random edge arrays have an average diameter of between 0.5 μm and 100 μm and an average thickness of less than 0.5 μm. The graphite platelets or graphite platelet fragments including the random edge arrays are present in the particles in an amount between 30 and 100 volume %, based on the total volume of the graphitic carbon material.

The above summary of the present disclosure is not intended to describe each embodiment of the present disclosure. The details of one or more embodiments of the disclosure are also set forth in the description below. Other features, objects, and advantages of the disclosure will be apparent from the description and from the claims.

### BRIEF DESCRIPTION OF THE DRAWINGS

The disclosure may be more completely understood in consideration of the following detailed description of various embodiments of the disclosure in connection with the accompanying figures, in which:

FIG. 1 shows an X-ray Diffraction (XRD) pattern and fit for Example 3 of the present disclosure.

FIG. 2 shows an XRD pattern and fit for Example 6 of the present disclosure.

FIG. 3 shows an XRD pattern of Example 12 of the present disclosure with the peaks of 2H graphite identified with triangles.

FIG. 4 shows an XRD pattern of Example 8 of the present disclosure with the peaks of 2H graphite identified with triangles and those of MgO identified with circles.

FIG. 5 shows a Scanning Electron Microscopy (SEM) micrograph of Example 1A of the present disclosure.

FIG. 6 shows an SEM micrograph of Example 1 of the present disclosure.

FIG. 7 shows an SEM micrograph of Example 2 of the present disclosure.

FIG. 8 shows an SEM micrograph of Example 3 of the present disclosure.

FIG. 9 shows an SEM micrograph of Example 4 of the present disclosure.

FIG. 10 shows an SEM micrograph of Example 5 of the present disclosure.

FIG. 11 shows an SEM micrograph of Example 6 of the present disclosure.

FIG. 12 shows an SEM micrograph of Example 7 of the present disclosure.

FIG. 13 shows an SEM micrograph of Example 8 of the present disclosure.

FIG. 14 shows an SEM micrograph of Example 9 of the present disclosure.

FIG. 15 shows an SEM micrograph of Example 10 of the present disclosure.

FIG. 16 shows an SEM micrograph of Example 11 of the present disclosure.

FIG. 17 shows an SEM micrograph of Example 12 of the present disclosure.

FIG. 18 shows an SEM micrograph of Example 13 of the present disclosure.

FIG. 19 shows an SEM micrograph (left) and schematic (right) of the crystallization process via nucleation and growth from a central seed of some aspects of the present disclosure.

FIG. 20 shows an SEM micrograph of some aspects of the present disclosure, depicting a central seed in the form of a graphite sphere fragment containing graphite platelets.

### DETAILED DESCRIPTION

High performance graphites for commercial lithium-ion (Li-ion) battery negative electrodes can be derived from the high temperature graphitization (>2800° C.) of soft carbon precursors, such as petroleum pitch. Such graphites are dense, have high gravimetric (˜350 mAh/g) and volumetric (˜720 Ah/L) capacities, low average voltage (˜125 mV vs Li/Li+), low surface area, good rate capability, and pack well during electrode calendering. However, high temperature processing adds to the cost of such artificial graphites.

Carbons from the low temperature (˜1000° C.) pyrolyzation of hard and soft carbons have also been suggested for use as Li-ion battery negative electrodes. However, hard carbons suffer from low density and a large voltage range, while low temperature carbons derived from soft carbon precursors can have high average voltages, low capacity from turbostratic disorder, and significant hysteresis from residual hydrogen.

Another pathway to the formation of graphites is to introduce metal catalysts during pyrolysis. Catalytic graphitization can significantly lower the graphitization temperature of carbons and both soft and “non-graphitizable” hard-carbon precursors can be graphitized by this method. Typically, a transition metal catalyst is used, such as iron. For instance, iron has been shown to graphitize hard carbon at 1200° C., producing a highly ordered graphite, suitable for Li-ion battery negative electrodes. However, large amounts of iron catalysts are required (˜40 wt. %) to graphitize hard carbons, ball milled carbon cannot be sufficiently catalyzed by this method at temperatures below 2000° C., and, furthermore, the iron catalyst is difficult to remove after pyrolysis, making such graphites impractical for use in Li-ion batteries.

A number of types of graphite morphologies have been observed in iron metal or nickel metal based melts, especially in iron alloys. When solidified, such melts have to be etched with a strong acid in order to recover the graphite encased within. For instance, Stefansescu et al. [D. M. Stefanescu, G. Alonso, P. Larranaga, E. De la Fuente, and R. Suarez, Acta Materialia 107 (2016) 102.] describe a number of graphite morphologies observed in solidified Fe—Si—C melts that were etched with acid, including lamellar graphite, spheroidal graphite, compacted graphite, coral graphite, superfine interdendtric graphite, and chunky graphite. Graphite platelets, in the form of hexagonal graphite single crystalline flakes, are observed to be the building blocks of many of these structures. The lattice constants a and c are used by convention to describe the length of the unit cell axis in the direction parallel and perpendicular to the single crystal hexagonal face, respectively. For instance, spheroidal graphite is in the form of a sphere or spherical shell composed of graphite platelets that are arranged such that their a-axes are tangential to the surface of the sphere.

Lamellar graphite is typically in the form of graphite flakes consisting of parallel graphite platelets stacked along their c-axis direction and with their a-axes parallel. Because the platelets undergo rotation along their c-axis as they stack [D. D. Double and A. Hellawell, Acta Metallurgica 17 (1969) 1071.], such flakes are typically not faceted, but have a round perimeter. Faceted thin hexagonal single crystalline graphite plates are rarely observed. Gornostayev et al. [Stanislav S. Gornostayev and Jouko J. Härkki, Carbon 45 (2007) 1145.] have observed single crystal graphite platelets in a sample of coke from the tuyere zone of an operating steel blast furnace. However, such particles are a minority phase in an irregular coke matrix, are only associated with coke/slag interfaces, are covered with impurities of Ca, Al, Si and O, and were formed by heating the coke to temperatures in excess of 2000° C. Hexagonal graphite flakes have also been observed in natural graphites. In all cases where hexagonal graphite flakes occur, the flakes tend to arrange themselves such that their basal planes are parallel. Branching of hexagonal graphite platelets typically also occurs in the direction of the basal plane, such that the basal planes of the graphite platelets remains parallel. The formation of graphite crystals that intersect themselves at random angles is not typically observed. This morphology of graphite has been seen when high levels of impurities, such as Sn, Pb, Sb, and Bi are added to cast iron melts [B. Lux, I. Minkoff, G. Mollard and E. Thury, “Branching of Graphite Crystals Growing from a Metallic Solution,” Metallurgy of Cast Iron, edited by B. Lux et al., Georgi Publishing Company, Switzerland, 1974, p. 495., Stanislav S. Gornostayev, and Jouko J. Härkki, Carbon 45 (2007) 1145.] However, the resulting graphite crystals were reported to have “extremely rough crystal faces”.

Rosette graphite (or DIN EN ISO 945 B-graphite) can also be observed in eutectic cells of solidified carbon containing iron melts [A. Velichko, C. Holzapfel, A. Siefers, K. Schladitz, F. Mücklich, Acta Materialia 56 (2008) 1981]. Such graphite is in the form of graphite flakes that emanate radially in three dimensions from a central point in the interior of the melt.

Since the melting point of iron and nickel are 1538° C. and 1455° C., respectively, obtaining graphite from iron and nickel based metal melts requires temperatures in excess of 1455° C. Typically such melts are heated to temperatures exceeding 2000° C. In addition, the amount of graphite within such solidified melts typically represents less than 20 atomic % or 16 volume % of the entire solidified melt. The metal from the solidified melt is difficult to remove and any remaining graphite can contain high amounts of slag or metal impurities. Any graphite platelet single crystals observed in such melts have been minority phases, comprising less than about 1% of the total carbon recovered as observed in SEM images.

Consequently, low cost methods of producing high performance graphites, that do not suffer from the drawbacks associated with low temperature pyrolyzation of hard and soft carbons, or the drawbacks associated with iron catalyzed pyrolyzation, are desirable.

As used herein,

the terms “graphite material” and “graphitic carbon material” refer to a material in which graphite is present in any amount;

the term “graphite platelet” refers to a faceted graphite single crystal in the form of a hexagonal prism, as observed by scanning electron microscopy (SEM);

the term “graphite platelet fragment” refers to a platelet that is a fragment of a graphite platelet in which the hexagonal facets can be discerned, as observed by SEM;

the term “graphitic spherical shell” refers to a hollow particle composed of graphite in the form of a shell that is spherical or ovoidal in shape, as observed by SEM;

the term “graphitic spherical shell fragment” refers to a particle that is a fragment of a graphitic spherical shell in which the spherical or ovoidal curvature can be discerned, as observed by SEM.

the term “decorated graphitic spherical” shell or “decorated graphitic spherical shell fragment” refer to graphitic spherical shells or graphitic spherical shell fragments in which an interior surface of the shell includes graphitic platelets that are arranged such that their basal planes are perpendicular to the shell surface, as observed by SEM;

the term “tessellated region” refers to a volume contained in a material (e.g., particle) having a region on the outer surface of the material, and that contains graphitic fibers or sheets of graphitic material that emanate radially from a single point on the surface of the material near the centroid of the region that is on the outer surface, as observed by SEM;

the term “tessellated material” refers to a material (e.g., particle) that is composed entirely of tessellated regions, such that the regions share common phase boundaries, as observed by SEM;

the term “random edge array” refers to a random arrangement of graphite platelets or graphite platelet fragments in which platelets are connected by one edge to a common substrate;

the term “perpendicular random edge array” refers to a random edge array in which the average orientation of the basal planes of the graphite platelets is perpendicular to the common substrate to which the platelet edges are connected;

the term “partially tessellated material” refers to a material (e.g., particle) that includes tessellated regions such that the boundaries of the tessellated regions are not in contact or are in partial contact with each other, as observed by SEM;

the terms “lithiate” and “lithiation” refer to a process for adding lithium to an electrode material or electrochemically active phase;

the terms “delithiate” and “delithiation” refer to a process for removing lithium from an electrode material or electrochemically active phase;

the terms “charge” and “charging” refer to a process for providing electrochemical energy to a cell;

the terms “discharge” and “discharging” refer to a process for removing electrochemical energy from a cell, e.g., when using the cell to perform desired work;

the phrase “charge/discharge cycle” refers to a cycle wherein an electrochemical cell is fully charged, i.e. the cell attains its upper cutoff voltage and the anode is at about 100% state of charge, and is subsequently discharged to attain a lower cutoff voltage and the anode is at about 100% depth of discharge;

the phrase “positive electrode” refers to an electrode (often called a cathode) where electrochemical reduction and lithiation occurs during a discharging process in a full cell;

the phrase “negative electrode” refers to an electrode (often called an anode) where electrochemical oxidation and delithiation occurs during a discharging process in a full cell;

the term “alloy” refers to a substance that includes chemical bonding between any or all of metals, metalloids, semimetals;

the phrase “catenated heteroatom” means an atom other than carbon (for example, oxygen, nitrogen, or sulfur) that is bonded to carbon atoms in a carbon chain so as to form a carbon-heteroatom-carbon chain; and

the term “trituration” or “triturating” refers to a process in which particulate material particles are homogeneously dispersed and brought into intimate contact with each other.

As used herein, the singular forms “a”, “an”, and “the” include plural referents unless the content clearly dictates otherwise. As used in this specification and the appended embodiments, the term “or” is generally employed in its sense including “and/or” unless the content clearly dictates otherwise.

As used herein, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Generally, in some embodiments, the present disclosure is directed to graphites made by heating non-graphitic carbon precursors in the presence of magnesium. Graphites produced by the methods of the present disclosure may be made from renewable sources of carbon (e.g. plant-derived hard carbons). Additionally, graphitization temperatures employed in the methods of the present disclosure are reduced by about 1800° C. relative to known methods used to produce battery-grade graphites.

In some embodiments, the present disclosure relates to methods of forming graphite containing carbon materials, or graphitic carbon materials. The methods may include combining a carbon source and magnesium. Suitable carbon sources may include graphitic carbons and non-graphitic carbons including activated carbons, hard carbons, ball milled carbons, cokes, graphites, and soft carbons. Such carbons may be derived from precursors, e.g. by heat treatment of aliphatic carbon containing molecules, aromatic carbon containing molecules, petroleum pitch or plant matter. In some embodiments, the carbon source may be in the form of a powder. Suitable carbon sources may include carbon powders having an average particle size less than 100 μm, less than 50 μm or less than 10 μm. Suitable magnesium sources may include magnesium powders having an average particle size of less than 100 μm, less than 50 μm or less than 10 μm in particle size.

In some embodiments, the carbon source and magnesium may be combined at a C:Mg mole ratio of 10:90, 30:70, 40:60, 50:50, 60:40, 70:30, 80:20 or 90:10. In some embodiments, additional components may be added. These may include other elements known to catalyze graphitization including boron, silicon, transition metals including iron, alkaline metals including lithium, and alkaline earth metals including calcium. Additional components may also include additives that are used as fluxes to promote diffusion, including oxides such as boron oxide; and halide salts of aluminum, the alkali metals and alkaline earth metals, such as the chloride or iodide salts of aluminum, lithium, sodium, potassium, magnesium or calcium.

In some embodiments, the step of combining the carbon source and the magnesium source may include contacting the carbon source with the magnesium and subjecting the resulting mixture to methods of triturating including grinding or agitation. Agitation may be provided, for example, by shaking, tumbling or stirring. Suitable agitation apparatus include v-blenders, ribbon mixers or paddle blenders. Grinding may be provided, for example by hand grinding (using, for example, a mortar and pestle type apparatus) or milling. Suitable milling apparatus include shaker mills (e.g., Spex mills), ball mills, rod mills, hammer mills, jet mills or attritor mills. In some embodiments, the resulting mixture comprises magnesium and carbon in a combined amount that is greater than 90 atomic %, based on the total number of atoms in the resulting mixture.

In some embodiments, the methods of the present disclosure may further include heating the carbon source/magnesium combination. Such heating may carried out during the trituration process, overlap with a portion of the trituration process, or following the trituration process. Any conventional heating techniques may be employed. In various embodiments, the carbon source/magnesium combination may be heated to temperatures of from between 500° C. and 2000° C., 500° C. and 1500° C., or 500° C. and 1000° C.; and may be heated for a period of between 0.5 hours and 10 hours, 10 hours and 50 hours, or 50 hours and 200 hours.

In some embodiments, either or both of the steps of combining the carbon source and the magnesium, and heating the combination may be carried out in a processing chamber having an inert atmosphere. As used herein, the “inert atmosphere” refers to a vacuum or an atmosphere filled with an inert gas, such as a noble gas, such as argon or nitrogen, or any other gas that has low chemical reactivity with carbon or magnesium. In some embodiments, the pressure of the inert gas is at atmospheric pressure or may be reduced so as to be lower than the atmospheric pressure. In some embodiments, the processing chamber is composed of a material that has low reactivity with carbon or magnesium or is provided with an inner liner that is composed of a material has low reactivity with carbon or magnesium. Such materials include stainless steel, graphite, glassy carbon, boron nitride, alumina, magnesium oxide, refractory metals such as tungsten and molybdenum, and high temperature alloys such as Hastelloy and Inconel. In some embodiments, the outside of the processing chamber may be protected from air during heating to inhibit corrosion to its outer surface. This may be accomplished, for example, by surrounding the processing chamber by an inert atmosphere or by burying the chamber under the earth.

In some embodiments, the methods of the present disclosure further include removing the non-carbon containing components (e.g., magnesium) from the magnesium containing graphitic carbon material to form a graphitic carbon material. Removing the non-carbon containing components may include contacting (immersing, rinsing, spraying, or the like) the magnesium containing graphitic carbon material with an acid. Suitable acids may include hydrochloric acid, nitric acid or sulfuric acid. Surprisingly, it was discovered that removal of the non-carbon containing components by contact with acid was far more effective for magnesium (in terms of both time and magnitude of removal) than for the removal of iron, which is required in known iron catalysis processes. In some embodiments, alternatively or additionally, the non-carbon containing components (e.g. magnesium) may be removed by thermal evaporation, including heating the magnesium containing graphitic carbon material in the presence of a vacuum or inert gas in a chamber where the magnesium containing graphitic carbon material is maintained at a temperature above 600° C. in one portion of the chamber and where another portion of the chamber is maintained at a lower temperature.

In some embodiments, following removal of the non-carbon containing components, optionally, the resulting graphitic carbon material may be subjected to either or both of conventional rinse and drying techniques. In some embodiments, the resulting graphitic carbon material may include carbon in an amount of between 30 and 100 mole %, 40 and 100 mole %, 70 and 100 mole %, or 70 and 90 mole %, based on the total number of moles of the graphitic carbon material. In some embodiments, the resulting graphitic carbon material may include graphite in an amount of between 1 and 100 mole %, 10 and 100 mole %, 20 and 100 mole %, 30 and 100 mole %, 40 and 100 mole %40 and 100 mole %, 70 and 100 mole %, or 70 and 90 mole %, based on the total number of moles of carbon in the graphitic carbon material. In some embodiments, the resulting graphitic carbon material may include graphite in an amount of between 1 and 100 vol. %, 10 and 100 vol. %, 20 and 100 vol. %, 30 and 100 vol. %, 40 and 100 vol. %, 70 and 100 vol. %, or 70 and 90 vol. %, based on the total volume of carbon in the graphitic carbon material. In some embodiments, the resulting graphitic carbon material may include a graphite phase that has a probability of random stacking that is less than 85%, less than 60%, less than 40%, less than 20% or less than 10%. In some embodiments, the resulting graphitic carbon material may include a graphite phase that exhibits 3R stacking order, where the 3R graphite is present in an amount less than 15 mole %, less than 5 mole % or less than 1 mole %, based on the total number of moles of graphite present in the graphitic carbon material.

In some embodiments, the graphitic carbon material may include magnesium in an amount of less than 75 weight %, 10 weight %, or 1 weight %, based on the total weight of the graphitic carbon material. Amounts of magnesium remaining in the graphitic carbon material may be in the form of elemental magnesium, magnesium oxide or magnesium carbonate. In some embodiments, the graphitic carbon material may include iron, nickel, aluminum, calcium or oxygen, individually or collectively, in an amount of less than 10 weight %, 5 weight %, 1 weight %, or less based on the total weight of the graphitic carbon material.

In some embodiments, an exterior surface of the graphitic carbon material may bear thereon a carbon coating. The carbon coating may be in the form of an amorphous carbon coating. Methods of providing a carbon coating may include chemical vapor deposition, physical vapor deposition or sputtering. Methods of providing a carbon coating may further include coating the graphitic carbon with a precursor that forms carbon after thermal decomposition, followed by heating. Suitable carbon coating precursors include aromatic and aliphatic organic molecules and polymers, such as polyvinyl chloride, cellulose, phenolic resins, polyacrylonitrile, polyaniline, sugars, and fatty acids. The carbon coating precursors may be applied by methods including milling, precipitation from solution, and spray drying.

In some embodiments a high degree of graphitization is achieved and the density of the graphitic carbon material as determined by helium pycnometry may be near that of pure graphite, which is 2.26 g/ml. In some embodiments, graphite is present in the graphitic carbon material in an amount of greater than 80 atomic %, greater than 85 atomic %, or greater than 90 atomic %, based on the total weight of the graphitic carbon material; and the density of the graphitic carbon material as determined by helium pycnometry is between 2.25 g/ml and 2.28 g/ml, between 2.26 g/ml and 2.28 g/ml or between 2.26 g/ml and 2.27 g/ml. In some embodiments, graphite is present in the graphitic carbon material in an amount of greater than 80 atomic %, greater than 85 atomic %, or greater than 90 atomic %, based on the total weight of the graphitic carbon material; and the density of the graphitic carbon material as determined by helium pycnometry is between 2.25 g/ml and 2.28 g/ml, between 2.26 g/ml and 2.28 g/ml or between 2.26 g/ml and 2.27 g/ml.

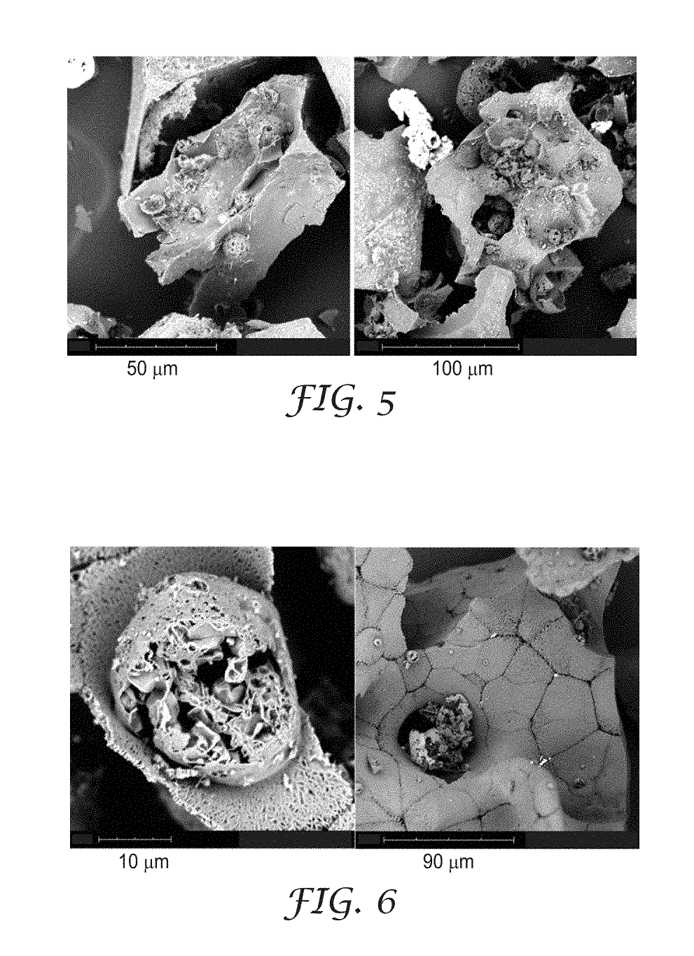

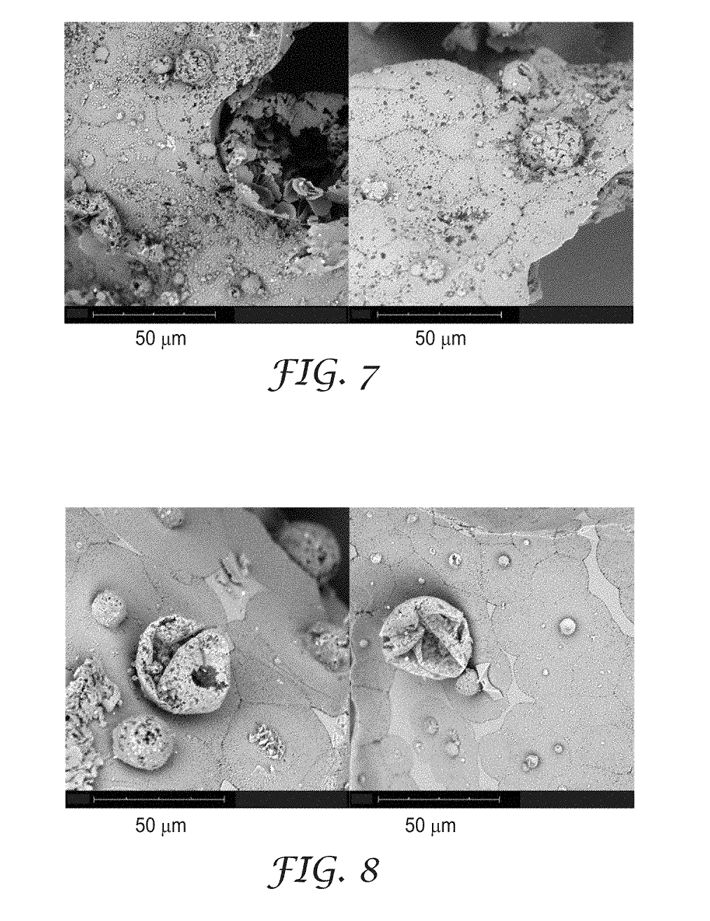

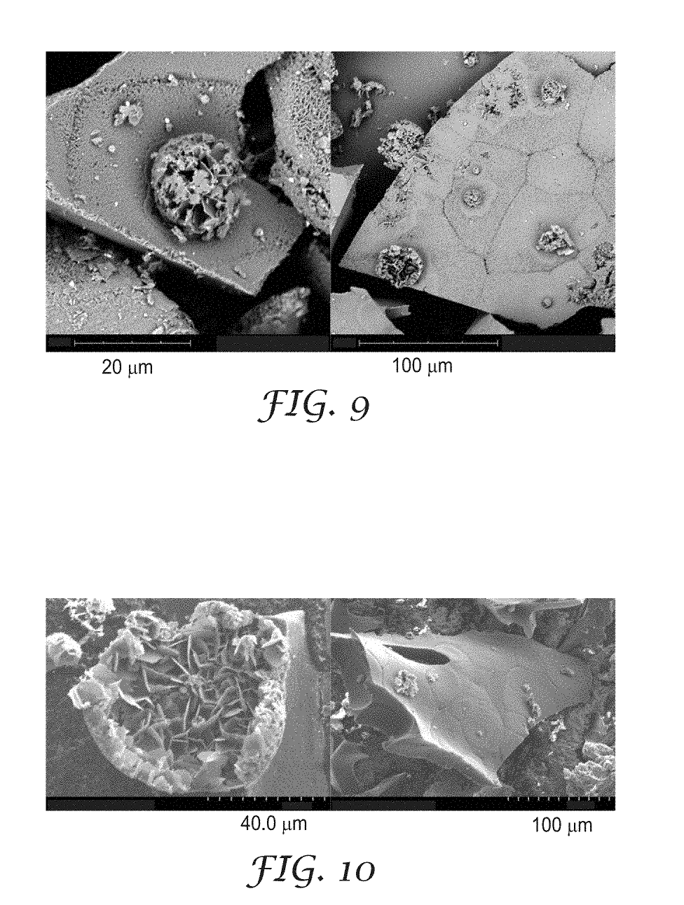

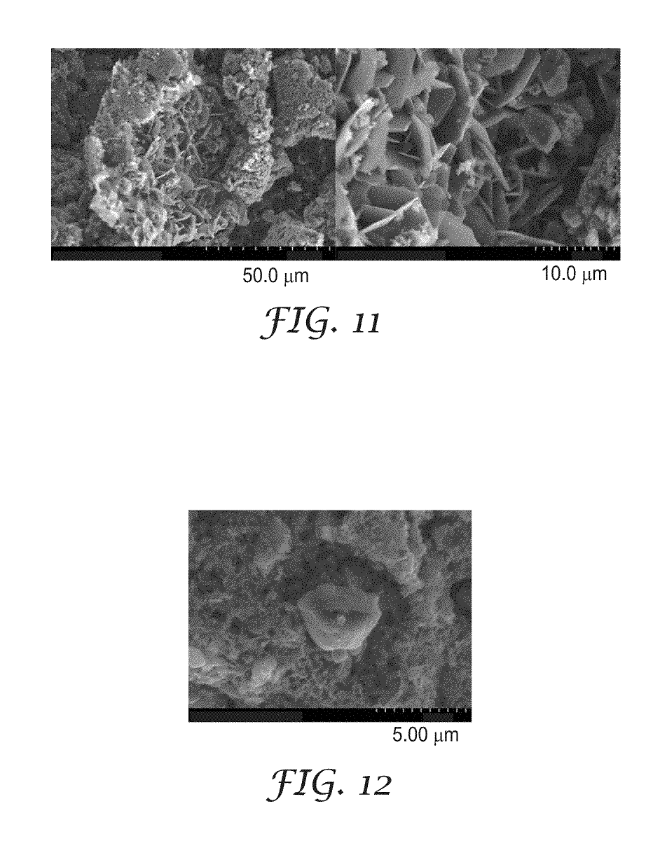

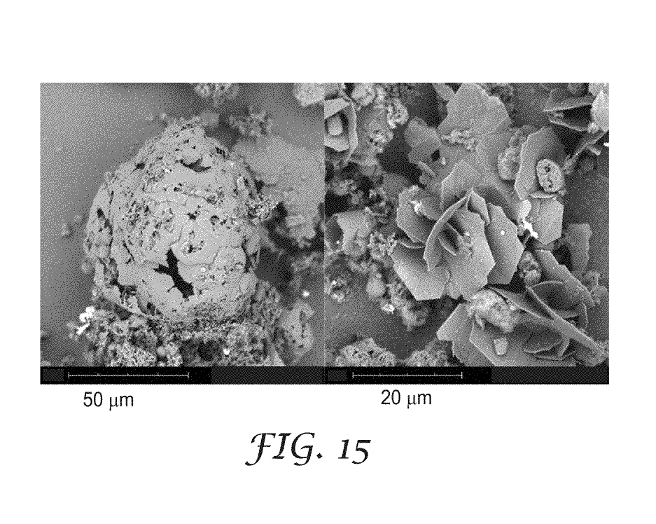

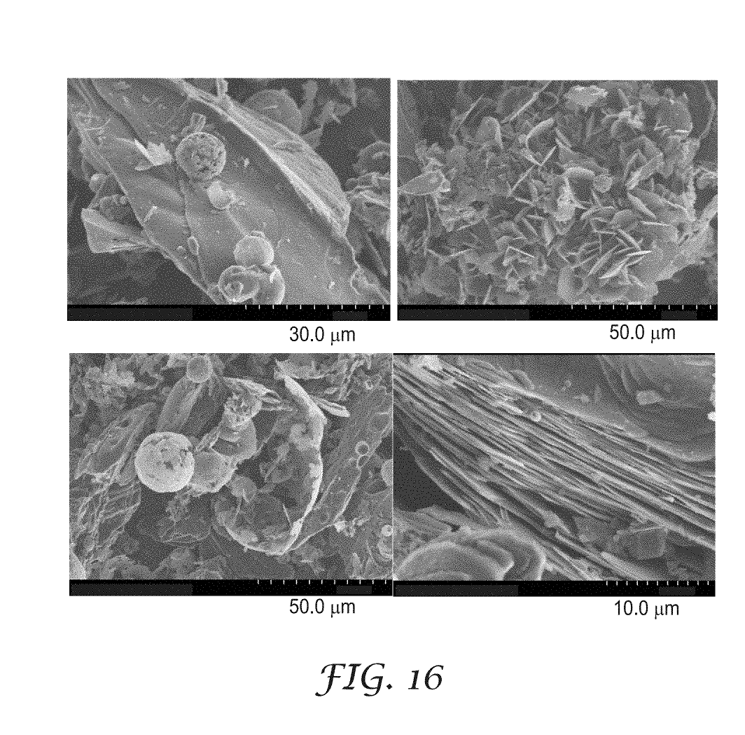

In some embodiments, the methods of the present disclosure may produce graphitic carbon materials having characteristics that have not been previously observed. For example, in some embodiments, graphitic carbon materials of the present disclosure may include decorated graphitic spherical shells, fragments of decorated graphitic spherical shells, or a combination thereof, as generally shown in FIGS. 5-11 and 14-16. The decorated graphitic shells or shell fragments may have an average diameter that is between 0.1 and 100 μm, 5 μm and 100 μm, 5 μm and 30 μm, 30 and 60 μm, or 60 μm and 100 μm. As used herein, the term “diameter” of a particle is the longest dimension between two points on the periphery of the particle, i.e., the distance between the two points on the periphery that are the furthest from one another.) In some embodiments, the decorated graphitic spherical shells and fragments of decorated graphitic spherical shells may be present in the graphitic carbon materials in an amount of between 1 and 100 vol. %, 20 and 100 vol. %, 20 and 70 vol. %, 1 and 20 vol. %, 20 and 50 vol. %, 50 and 70 vol. %, or 70 and 100 vol. %, based on the total volume of the graphitic carbon material.

In various embodiments, graphitic carbon materials of the present disclosure may include tessellated regions, as generally shown in FIGS. 5-10. The tessellated regions may be present in the graphitic carbon materials in an amount of between 1 and 100 vol. %, 20 and 100 vol. %, 20 and 70 vol. %, 1 and 20 vol. %, 20 and 50 vol. %, 50 and 70 vol. %, or 70 and 100 vol. %, based on the total volume of the graphitic carbon material. The tessellated regions may have an average diameter of between 1 and 100 μm, 1 and 20 μm, 20 and 50 μm, 50 and 70 μm, or 70 and 100 μm. In some embodiments, the graphitic carbon materials may be in the form of particles. The portion of the particles that are not in the form of decorated graphitic spherical shells, fragments of decorated graphitic spherical shells or perpendicular random edge arrays may be composed entirely of tessellated regions, or may include tessellated regions and non-tessellated regions, as generally shown in FIGS. 6, 7, 9, and 10. In embodiments in which the particles include tessellated regions and non-tessellated regions, as generally shown in FIG. 8, the tessellated regions may be present in the particles in an amount of between 1 and 100 vol. %, 20 and 100 vol. %, 20 and 70 vol. %, 1 and 20 vol. %, 20 and 50 vol. %, 50 and 70 vol. %, or 70 and 100 vol. %, based on the total volume of the particles, and the non-tessellated regions may be present in the particles in an amount of between 0 and 20 vol. %, 20 and 50 vol. %, 50 and 70 vol. %, or 70 and 100 vol. %, based on the total volume of the particles. In any of the above-described embodiments, the non-tessellated regions that are not in the form of decorated graphitic spherical shells, fragments of decorated graphitic spherical shells or perpendicular random edge arrays may not comprise graphite.

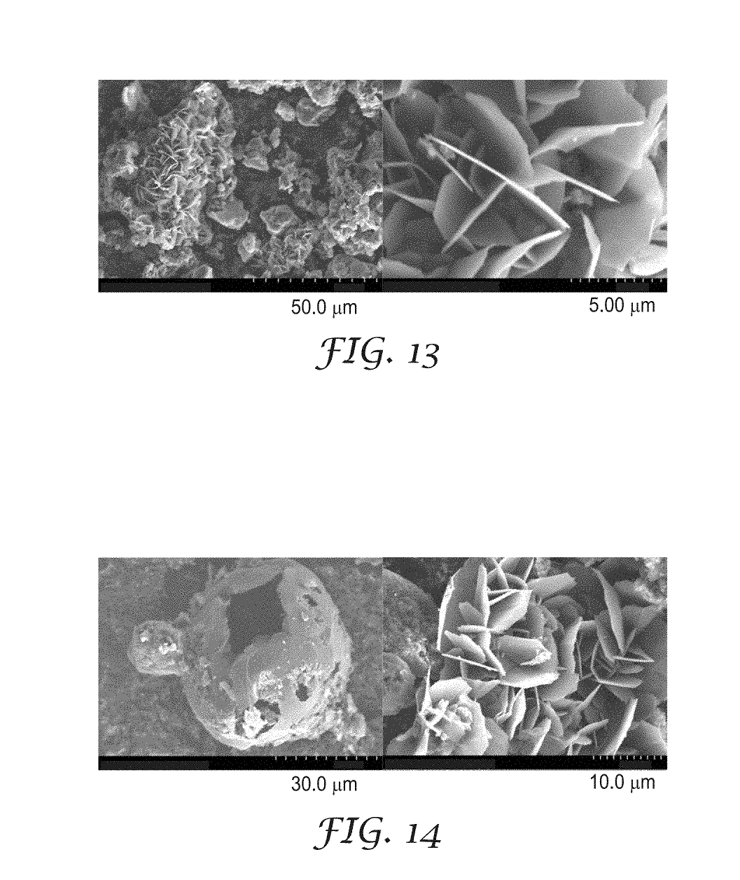

In some embodiments, including in any of the above-described embodiments, the graphitic carbon materials may further include perpendicular random edge arrays, as generally shown in FIGS. 13, 14, 16, and 17. The graphite platelets or graphite platelet fragments comprising the perpendicular random edge arrays may have an average thickness (distance between the two hexagonal faces) of less than 1 μm, less than 200 nm, less than 50 nm, or less than 20 nm; and an average diameter of between 1 μm and 5 μm, 1 μm and 5 μm, 5 μm and 25 μm, or 25 μm and 50 μm. In some embodiments the graphitic carbon materials may include graphite platelets or graphite platelet fragments comprising the perpendicular random edge arrays intersect each other, as generally shown in FIGS. 13, 14, 16, and 17. In some embodiments, the perpendicular random edge arrays may be present in the graphitic carbon materials in an amount of between 1 and 100 vol. %, 5 and 100 vol. %, 1 and 20 vol. %, 20 and 50 vol. %, 50 and 70 vol. %, or 70 and 100 vol. %, based on the total volume of the graphitic carbon material.

In embodiments in which the graphitic carbon materials include graphitic spherical shells or fragments of graphitic spherical shells, the graphitic carbon materials may further include hexagonal graphite platelets arranged perpendicularly with respect to an exterior surface of the shell or shell fragment, as generally shown in FIGS. 5-11, 14-16.

In some embodiments, including in any of the above-described embodiments, the graphitic carbon materials may include either or both of the 2H graphite phase and the 3R graphite phase. The graphitic carbon materials may have a BET surface area of between 10 m²/g and 1000 m²/g, 10 m²/g and 30 m²/g, 30 m²/g and 100 m²/g, or 100 m²/g and 500 m²/g, or even larger.

In some embodiments, a coating may be applied to the graphitic carbon material. In some embodiments, a carbon coating may be applied to the graphitic carbon material by methods such as chemical vapor deposition; combining the graphitic carbon material with an organic precursor, such as polyvinylchloride, and heating; or mixing or grinding the graphitic carbon material with small carbon particles, such as graphene, carbon nanotubes or carbon black.

In some embodiments, the present disclosure is further directed to electrochemical cells (e.g., lithium ion electrochemical cells) that include the above-described graphitic carbon materials. Generally, the electrochemical cells may include a negative electrode, a positive electrode, an electrolyte, and a separator. In the electrochemical cell, the electrolyte may be in contact with both the positive electrode and the negative electrode, and the positive electrode and the negative electrode are not in physical contact with each other; typically, they are separated by a separator film sandwiched between the electrodes.

In some embodiments, the negative electrodes may include a current collector having disposed thereon a negative electrode composition. The current collector may be formed of a conductive material such as a metal (e.g., copper, stainless steel or nickel), or a carbon composite. In some embodiments, the negative electrode composition may include any of the above-described graphitic carbon materials. The graphitic carbon materials may be incorporated into the negative electrodes as an active material or as a conductive diluent. In some embodiments, the graphitic carbon materials may be present in the negative electrode in an amount of greater than 10 wt. %, greater than 20 wt. %, greater than 50 wt. %, or greater than 70 wt. %, based upon the total weight of the negative electrode composition coating; or between 5 wt. % and 90 wt. %, between 30 wt. % and 80 wt. %, between 40 wt. % and 60 wt. %, between 45 wt. % and 55 wt. %, between 80 wt. % and 90 wt. %, or between 85 wt. % and 90 wt. %, based upon the total weight of the negative electrode composition. Additionally, or alternatively, the negative electrode materials may include active materials including any or all of silicon alloys, tin alloys, metal oxides, and carbonaceous materials including artificial graphites, natural graphites, and hard carbons. Additionally, the negative electrodes may include one or more additives such as binders, conductive diluents, fillers, adhesion promoters, or thickening agents for dispersion viscosity modification.

In some embodiments, the positive electrodes may include a current collector having disposed thereon a positive electrode composition. The current collector may be formed of a conductive material such as a metal (e.g., aluminum, stainless steel), or a carbon composite. In various embodiments, the positive electrode composition may include an active material. The active material may include a lithium metal oxide. In an exemplary embodiment, the active material may include lithium transition metal oxide intercalation compounds such as LiCoO₂, LiCo_{0.2}Ni_{0.8}O₂, LiMn₂O₄, LiFePO₄, LiNiO₂, or lithium mixed metal oxides of manganese, nickel, and cobalt in any effective proportion, or of nickel, cobalt, and aluminum in any effective proportion. Blends of these materials can also be used in positive electrode compositions. Other exemplary cathode materials are disclosed in U.S. Pat. No. 6,680,145 (Obrovac et al.) and include transition metal grains in combination with lithium-containing grains. Suitable transition metal grains include, for example, iron, cobalt, chromium, nickel, vanadium, manganese, copper, zinc, zirconium, molybdenum, niobium, or combinations thereof with a grain size no greater than about 50 nanometers. Suitable lithium-containing grains can be selected from lithium oxides, lithium sulfides, lithium halides (e.g., chlorides, bromides, iodides, or fluorides), or combinations thereof. The positive electrode composition may further include additives such as binders (such as polymeric binders (e.g., polyvinylidene fluoride), conductive diluents (e.g., carbon, carbon black, flake graphite, carbon nanotubes, conductive polymers), fillers, adhesion promoters, thickening agents for coating viscosity modification such as carboxymethylcellulose, or other additives known by those skilled in the art.

In various embodiments, useful electrolyte compositions may be in the form of a liquid, solid, or gel. The electrolyte compositions may include a salt and a solvent (or charge-carrying medium). Examples of liquid electrolyte solvents include ethylene carbonate, dimethyl carbonate, ethyl methyl carbonate, diethyl carbonate, propylene carbonate, fluoroethylene carbonate, tetrahydrofuran (THF), acetonitrile, and combinations thereof. In some embodiments the electrolyte solvent may comprise glymes, including monoglyme, diglyme and higher glymes, such as tetraglyme. Examples of suitable lithium electrolyte salts include LiPF₆, LiBF₄, LiClO₄, lithium bis(oxalato)borate, LiN(CF₃SO₂)₂, LiN(C₂F₅SO₂)₂, LiAsF₆, LiC(CF₃SO₂)₃, and combinations thereof.

In some embodiments, the lithium-ion electrochemical cells may further include a microporous separator, such as a microporous material available from Celgard LLC, Charlotte, N.C. The separator may be incorporated into the cell and used to prevent the contact of the negative electrode directly with the positive electrode.

The disclosed electrochemical cells can be used in a variety of devices including, without limitation, portable computers, tablet displays, personal digital assistants, mobile telephones, motorized devices (e.g., personal or household appliances, power tools and vehicles), instruments, illumination devices (e.g., flashlights) and heating devices. Multiple lithium ion electrochemical cells of this disclosure can be combined to provide a battery pack.

The present disclosure further relates to methods of making negative electrodes that include the above-described negative electrode compositions. In some embodiments, the method may include mixing the above-described electrochemically active materials, along with any additives such as binders, conductive diluents, fillers, adhesion promoters, thickening agents for coating viscosity modification and other additives known by those skilled in the art, in a suitable coating solvent such as water or N-methylpyrrolidinone to form a coating dispersion or coating mixture. The dispersion may be mixed thoroughly and then applied to a foil current collector by any appropriate coating technique such as knife coating, notched bar coating, dip coating, spray coating, electrospray coating, or gravure coating. The current collectors may be thin foils of conductive metals such as, for example, copper, stainless steel, or nickel foil. The slurry may be coated onto the current collector foil and then allowed to dry in air, inert gas or vacuum, and optionally by drying in a heated oven, typically at about 80° to about 300° C. for about an hour to remove the solvent.

The present disclosure further relates to methods of making lithium ion electrochemical cells. In various embodiments, the method may include providing a negative electrode as described above, providing a positive electrode that includes lithium, and incorporating the negative electrode and the positive electrode into an electrochemical cell comprising a lithium-containing electrolyte.

### Listing of Embodiments

1. A graphitic carbon material comprising:
   decorated graphitic spherical shells or fragments of decorated graphitic spherical shells, wherein the decorated graphitic spherical shells or fragments of decorated graphitic spherical shells have an average diameter of between 0.1 and 100 μm.
2. The graphitic carbon material of embodiment 1, wherein any decorated graphitic spherical shells or fragments of graphitic spherical shells, collectively, are present in the graphitic carbon material in an amount of between 40 and 100 vol. %, based on the total volume of the graphitic carbon material.
3. A graphitic carbon material comprising:
   tessellated regions, wherein the tessellated regions are present in the graphitic carbon material in an amount of between 5 and 100 vol. %, based on the total volume of the graphitic carbon material.
4. The graphitic carbon material of embodiment 3, wherein the graphitic carbon material is in the form of particles, and wherein the particles comprise tessellated regions and non-tessellated regions.
5. The graphitic carbon material of embodiment 4, wherein the tessellated regions are present in the particles in an amount of between 5 and 100 vol. %, based on the total volume of the particles.
6. The graphitic carbon material according to any one of embodiments 4-5, wherein the non-tessellated regions are present in the particles in an amount of between 1 and 95 vol. %, based on the total volume of the particles.
7. The graphitic carbon material according to any one of embodiments 4-6, wherein the non-tessellated regions comprise amorphous carbon.
8. The graphitic carbon material according to any one of embodiments 4-7, wherein the tessellated regions have an average diameter of between 10 and 200 μm.
9. A graphitic carbon material comprising:
   random edge arrays comprising a random arrangement of graphite platelets or graphite platelet fragments in which platelets are connected by one edge to a common substrate, wherein the graphite platelets or graphite platelet fragments comprising the random edge arrays have an average diameter of between 0.5 μm and 100 μm and an average thickness of less than 0.5 μm and wherein the graphite platelets or graphite platelet fragments comprising the random edge arrays are present in the particles in an amount between 30 and 100 volume %, based on the total volume of the graphitic carbon material.
10. The graphitic carbon material of embodiment 9, further comprising perpendicular random edge arrays.
11. The graphitic carbon material of embodiment 9, wherein at least a portion of the graphite platelets or graphite platelet fragments comprising the perpendicular random edge arrays intersect each other.
12. The graphitic carbon material according to any one of embodiments 10-11, wherein the graphitic carbon material comprises decorated graphitic spherical shells or decorated graphitic spherical shell fragments.
13. The graphitic carbon material according to any one of embodiments 1-12, wherein graphite is present in the graphitic carbon material in an amount of between 50 and 100%, based on total volume of the graphic carbon material.
14. The graphitic carbon material according to any one of embodiments 1-13, wherein the graphitic carbon materials comprise either or both of the 2H graphite phase and the 3R graphite phase.
15. The graphitic carbon material according to any one of embodiments 1-14, wherein the graphitic carbon materials have a BET surface area of between 30 and 500 m²/g.
16. The graphitic carbon material according to any one of embodiments 1-15, wherein the graphitic carbon material contains less than 1 atomic % of Fe, Al, Si or Ca.
17. The graphitic carbon material according to any one of the embodiments 1-16, wherein the graphitic carbon material bears a carbon coating on an external surface thereof.
18. The graphitic carbon material according to any one of the embodiments 1-17, wherein the graphitic carbon material comprises graphite in an amount of greater than 85 atomic %, based on the total number of carbon atoms present in the graphitic carbon material, and the graphitic carbon material has density as measured by helium pycnometry of between 2.25 g/ml and 2.28 g/ml.
19. The graphitic carbon material according to any one of the embodiments 1-18, wherein the graphitic carbon material comprises carbon in an amount that is greater than 98 atomic %, based on the total number of atoms in the graphitic carbon material.
20. An electrode comprising:
   an electrode composition comprising the graphitic carbon material according to any one of embodiment 1-19; and
   a current collector.
21. An electrochemical cell comprising:
   the electrode of embodiment 20.
22. The electrochemical cell of embodiment 21, wherein the electrochemical cell comprises a lithium ion electrochemical cell, and wherein the electrode comprises a negative electrode.
23. The electrochemical cell of embodiment 22, further comprising a positive electrode and an electrolyte.
24. An electronic device comprising the electrochemical cell according to any one of embodiments 21-23.
25. A method of making a graphitic carbon material, the method comprising:
   combining a carbon source and magnesium to form a mixture;
   triturating the mixture;
   heating the mixture in an inert atmosphere; and
   following the step of triturating the mixture or heating the mixture in an inert atmosphere, removing the non-carbon containing components from the mixture.
26. The method of making a graphitic carbon material according to embodiment 25, wherein the carbon source comprises a hard carbon or a soft carbon.
27. The method making a graphitic carbon material according to embodiment 25-26, wherein the mixture comprises magnesium and carbon in a combined amount that is greater than 90 atomic %, based on the total number of atoms in the mixture.
28. The method of making a graphitic carbon material according to any one of embodiments 25-27, wherein heating the mixture in an inert atmosphere comprises heating the mixture to a temperature in the range of 800° C. to 2500° C.
29. The method of making a graphitic carbon material according to any one of embodiments 25-28, wherein removing the non-carbon containing components from the mixture comprises contacting the mixture with an acid.
30. The method of making a graphitic carbon material according to any one of embodiments 25-29, following the step of removing the non-carbon containing components from the mixture, coating the graphitic carbon material with a layer of carbon.

The operation of the present disclosure will be further described with regard to the following detailed examples. These examples are offered to further illustrate various specific embodiments and techniques. It should be understood, however, that many variations and modifications may be made while remaining within the scope of the present disclosure.

### Examples

The following examples are offered to aid in the understanding of the present disclosure and are not to be construed as limiting the scope thereof. Unless otherwise indicated, all parts and percentages are by weight.

### Materials Used

Mg powder: 325 mesh magnesium powder was obtained from Hart Metal, Inc., USA
Activated Carbon (AC): Granulated activated carbon (Nuchar WV-B, 10×25 Mesh, Westvaco, Covington Va.) was dried at 600° C. in Ar, then transferred to an Ar-filled glovebox without air exposure.
Hard carbon (HC): 96% α-D-Glucose (Aldrich, USA) was dewatered by heating at 180° C. in air for 24 hours. The dewatered glucose was then heated in a tube furnace under argon at 1100° C. for three hours. The resulting hard carbon was transferred to an Ar-filled glovebox without air exposure.
Coke: #4491 coke (Asbury Carbons, USA) was used as received.

### Sample Preparation Procedures

### Spex Milling Conditions:

In an Argon-filled glovebox, precursor powders in a prescribed mole ratio in an amount such that the total precursor powder volume (as determined from bulk densities) was 1.5 ml were added to a hardened steel high energy ball milling vial (Spex SamplePrep, US) along with 115 g of 3/16″ stainless steel balls. The vial was sealed under an Argon atmosphere and then milled for 2 hours in a Spex high energy ball mill (Spex SamplePrep, US).

### Hand Grinding Conditions:

In an Ar-filled glovebox, precursor powders in a prescribed mole ratio in an amount such that the total precursor powder volume (as determined from bulk densities) was about 1 ml was added to a mortar and pestle and ground by hand for about 5 minutes.

### Graphitization Conditions:

For each graphitization, in an Ar-filled glovebox about 1 ml of powders were placed in a 7 inch long, 0.25 inch diameter stainless steel tube and the tube was sealed at both ends using stainless steel Swagelok end cap fittings. The tubes were then heated at different temperatures and times under flowing Ar. After cooling to room temperature, the tubes were opened in an in air and their contents collected.

Magnesium Removal from Graphitized Samples:

Mg was removed from graphitized samples by first rinsing the sample in distilled water. The samples were then immersed for 12 hours in a 50 ml solution containing 1M HCl and 3 drops of ethanol (Aldrich, 98%). The sample was then washed three times with this solution in a Buchner funnel and then washed with distilled water until the pH of the wash water was 7. The residual graphite was then collected and dried for 120° C. in air for four hours. Some samples were post-heated at 600° C.

### Sample Characterization

### X-Ray Diffraction (XRD) Measurements and Fit Procedures

XRD patterns were collected using a Rigaku Ultima IV diffractometer equipped with a Cu target, a dual position graphite diffracted beam mono-chromator and a scintillation counter detector.

Percent random stacking and percent 3R graphite were obtained by fitting the XRD patterns using CarbonXS software described in H. Shi, J. N. Reimers, and J. R. Dahn, Structure-refinement program for disordered carbons, J. Appl. Crystallogr., 26 (1993), pp. 827-836.

To determine the graphitic and amorphous carbon content of the powders, the XRD patterns were fit between the angles of 20 and 30 degrees 2-theta as follows. XRD patterns were measured between 20 and 80 degrees 2-theta. A linear baseline with zero slope was used for the fits. The baseline level used for each fit was the average of the intensity observed between 35 to 39 degrees 2-theta, where no diffraction peaks were observed. Peaks with positions less than 25 degrees 2-theta and having a full width at half maximum (FWHM) greater than 5 degrees 2-theta were assigned to be arising from amorphous carbon and peaks with positions in the range of 26 to 27 degrees 2-theta and having a FWHM of less than 2 degrees 2-theta were assigned to arise from graphitic carbon 002 peaks. Three pseudo-Voigt peaks were included in the fit. Two peaks with positions in the range of 26 to 27 degrees 2-theta were used to fit the graphite 002 peaks, each of these peaks having a FWHM of less than 2 degrees 2-theta. One peak with a position less than 25 degrees 2-theta and a FWHM greater than 5 degrees 2-theta was used to fit the amorphous carbon peak. The relative area of the graphitic carbon peaks to the area of all fitted peaks was used to determine the molar percent graphitic carbon in the sample with respect to all the elemental carbon in the sample. The relative area of the amorphous carbon peak to the area of all fitted peaks was used to determine the molar percent graphitic carbon in the sample with respect to all the elemental carbon in the sample.

### Scanning Electron Microscopy Measurements

Sample morphology was studied with a Phenom G2-pro Scanning Electron Microscope (SEM, Nanoscience, Arizona, US) and a Hitachi S-4700 FEG Scanning Electron Microscope (SEM). Energy Dispersive X-ray spectroscopy (EDS) data was collected using a Hitachi S-4700 FEG Scanning Electron Microscope with an Oxford Inca Energy Dispersive X-ray analysis system.

### Electrochemical Measurements

Electrode slurries containing 90 wt. % graphitized carbon, 5 wt. % carbon black (Super-P, Erachem Europe), and 5 wt. % polyvinylidene difluoride (PVdF, KYNAR HSV 900, Arkema, US) binder in 99.5% 1-methyl-2-pyrrolidinone (Sigma-Aldrich, US) were mixed for one hour using a planetary ball mill (PM 200 from Retsch, Germany) with four 7/16″ WC balls at 100 rpm. A thin layer of slurry was coated on Cu foil (Furukawa Electric, Japan) using a 0.004 inch coating bar and dried in air at 120° C. for one hour.

Disk electrodes (13 mm diameter) were punched from the coated foil and were transferred into an argon-filled glove box and assembled in 2325-type coin cells with a lithium reference/counter electrode and an electrolyte composed of 1M LiPF6 (BASF, US) in a solution of monofluoroethylene carbonate (FEC), ethylene carbonate (EC) and diethyl carbonate (DEC) (volume ratio 1:3:6, battery grade, all from BASF, US). Two layers of Celgard 2300 separator and two copper spacers with a total thickness of 0.06 inches were used in each cell. Cells were cycled with a Maccor Series 4000 Automated Test System at a C/10 rate and trickled discharged to C/40 for the first cycle, and a C/5 rate and trickled discharged to C/20 for all subsequent cycles. All examples were cycled in a voltage range from 0.005 to 2.0 V, except Example 11 which was cycled in a voltage range from 0.005 to 1.0 V. C-rates were calculated by assuming that graphite has a capacity of 372 mAh/g.

### Surface Area Measurements

Single-point Brunauer-Emmett-Teller (BET) surface area measurements (30% N2 in He) were made using a Micromeritics Flowsorb II 2300 surface area analyzer.

### Density Measurements

Density measurements were made with an AccuPyc II 1340 gas displacement pycnometer using He gas (ultrahigh purity, 99.999%).

TABLE 1
Summary of Examples 1A-12

| | | | C:Mg | graphitization | | |
|---|---|---|---|---|---|---|
| | carbon | grinding | mole | temperature | graphitization | BET Surface |
| Example | precursor | method | ratio | (° C.) | time (hours) | Area (m²/g) |
| 1A | HC | hand | 60:40 | 800 | 3 | |
| | | grinding | | | | |
| 1 | HC | hand | 60:40 | 900 | 3 | |
| | | grinding | | | | |
| 2 | HC | hand | 60:40 | 1000 | 3 | |
| | | grinding | | | | |
| 3 | HC | hand | 50:50 | 800 | 3 | |
| | | grinding | | | | |
| 4 | HC | hand | 50:50 | 900 | 3 | 82 |
| | | grinding | | | | |
| 5 | HC | hand | 50:50 | 1000 | 3 | 88 |
| | | grinding | | | | |
| 6 | HC | Spex | 50:50 | 900 | 3 | 55 |
| 7 | HC | Spex | 50:50 | 1000 | 3 | 88 |
| 8 | AC | Spex | 50:50 | 900 | 3 | 328 |
| 9 | AC | Spex | 50:50 | 1000 | 3 | 142 |
| 10 | AC | Spex | 50:50 | 1000 | 20 | |
| 11 | Coke | hand | 50:50 | 1000 | 3 | |
| | | grinding | | | | |
| 12 | Coke | Spex | 50:50 | 1000 | 3 | |

### Preparation of Example 13

Example 13 was prepared in the same manner as Example 7, except that the resulting graphitic carbon powder was carbon coated. 0.5 g of the graphite made according to Example 7 was mixed with 0.7 g PVC, followed by planetary milling in a Retsch PM200 Planetary Ball Mill with three 11.25 mm tungsten carbide balls for one hour at 100 rpm. The resulting graphite-PVC mixture was then heated under an Ar flow at 280° C. for 0.5 h, then 450° C. for 0.5 h, 900° C. for 1 h and then cooled to room temperature before exposing to air.

### XRD Results

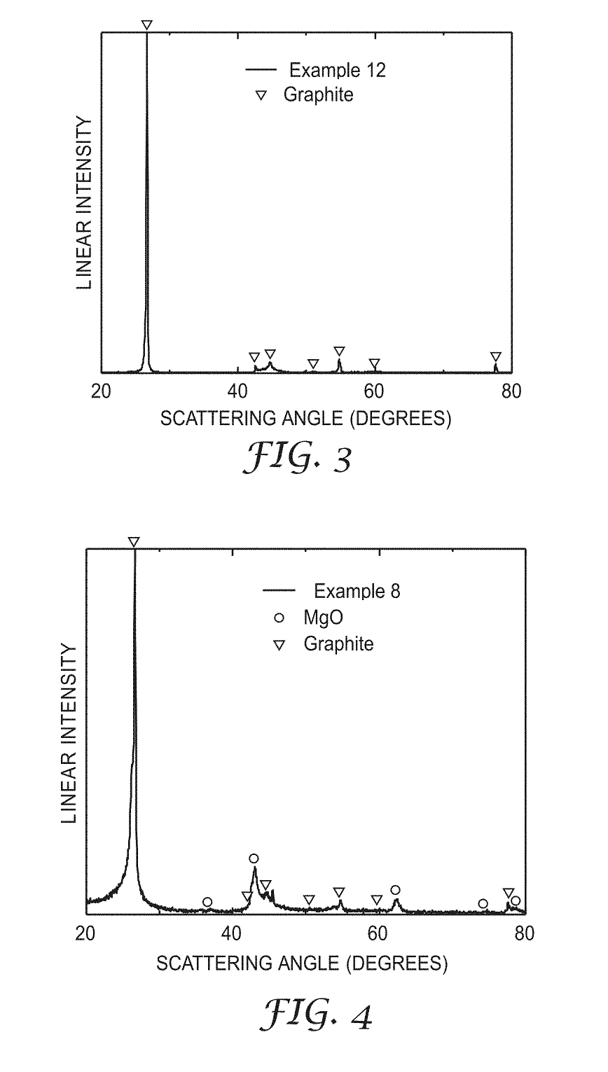

All examples showed a strong peaks in their XRD patterns, characteristic of the hexagonal phase (2H) or rhombohedral phase (3R) of graphite. The XRD pattern of Example 12 exhibited only peaks from 2H and 3R graphite, the peaks from 2H graphite being identified in FIG. 3. Remnants of the catalyst were found only in Example 8. FIG. 4 shows the XRD pattern of Example 8 with the peaks from 2H graphite and an MgO phase identified. This demonstrates that this method is effective in removing the catalyst via a simple aqueous acid rinse.

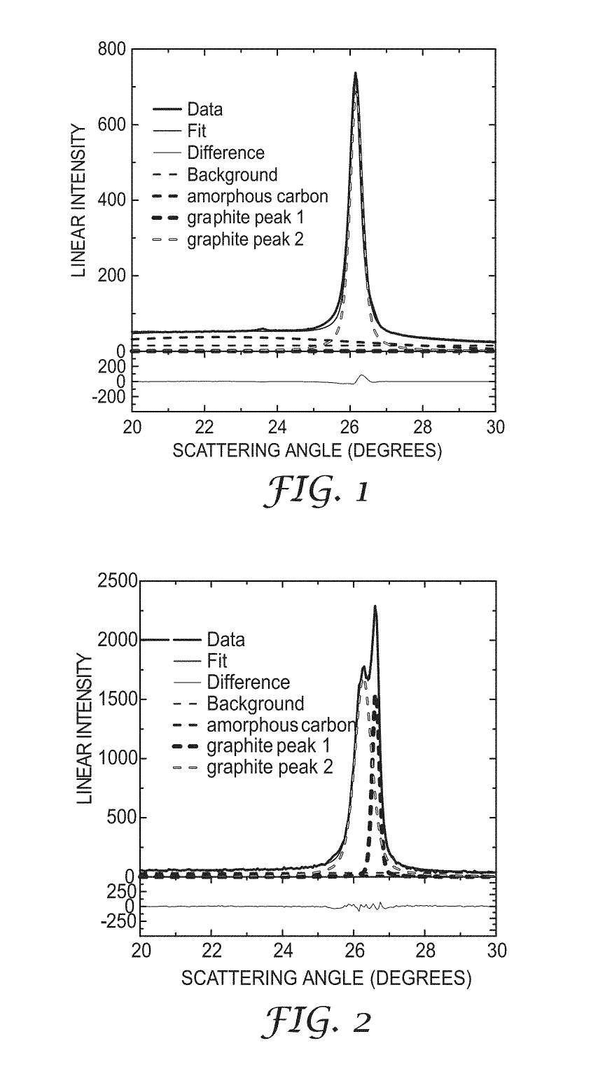

Fitting results using CarbonXS and the test for amorphous and graphitic carbon are provided in Table 2. FIGS. 1 and 2 show XRD patterns for Examples 3 and 6, respectively, which have been fit using these procedures to determine the amounts of amorphous carbon and graphitic carbon. Example 1A, 8, and 11 could not be fit using CarbonXS, so the amount of random stacking and 3R graphite was not determined for these samples. To verify the fitting procedures described previously, XRD fitting was also conducted on Comparative Example CE1, a sample of commercial artificial graphite (MAGE from Hitachi, US). The fitting procedures indicated that this was a highly graphitic sample with a low probability of random stacking and low amorphous carbon content, as would be expected.

TABLE 2
Results of XRD Fits

| | | Random | 3R | Amorphous | Graphitic |
|---|---|---|---|---|---|
| Exam- | CarbonXS | Stacking* | graphite* | Carbon* | Carbon* |
| ple | Model | (%) | (%) | (%) | (%) |
| 1A | — | — | — | 88.68 | 11.32 |
| CE1 | two layer | 6 | 2.5 | 4.91 | 95.09 |
| 1 | single layer | 68.7 | NA | 31.55 | 68.45 |
| 2 | single layer | 53.0 | NA | 20.54 | 79.46 |
| 3 | single layer | 83.9 | NA | 50.79 | 49.21 |
| 4 | single layer | 63.6 | NA | 11.40 | 88.60 |
| 5 | single layer | 49.1 | NA | 11.40 | 88.60 |
| 6 | two layer | 32.6 | 7.6 | 10.00 | 90.00 |
| 7 | two layer | 18.1 | 11.1 | 10.41 | 89.59 |
| 8 | — | — | — | 41.26 | 58.74 |
| 9 | two layer | 31.6 | 4.1 | 12.25 | 87.75 |
| 10 | two layer | 20.6 | 6.1 | 12.09 | 87.91 |
| 11 | | | | 73.34 | 26.66 |
| 12 | two layer | 12.6 | 10.1 | 5.79 | 94.21 |
| 13 | two layer | 16.7 | 8.6 | 17.81 | 82.19 |

*All percentages are in weight percent or atomic percent of the total carbon present in the sample

Highly ordered synthetic graphites made at temperatures above 2000° C. can have probabilities of random stacking that are 42% or less (e.g., see Tao Zheng, J. N. Reimers, and J. R. Dahn, Effect of turbostratic disorder in graphitic carbon hosts on the intercalation of lithium, Phys. Rev. B, 51 (1995) 734). Many of the above samples are more highly ordered than this, even though they were heated at much lower temperatures. In particular, Examples 7, 12, and 13 have degrees of ordering that are similar to synthetic graphites made at 2700° C.

### SEM Results

SEM micrographs for Example 1A and Examples 1-13 are provided in FIGS. 5-18, respectively. Example 1A and Examples 6, 10, and 11 comprised whole or partial graphite spheres that were 1-150 μm in diameter that were hollow or contained well-defined graphite platelets. Some spheres were hollow and were collapsed (e.g. like a deflated ball, as shown in FIG. 8). All examples comprised graphite platelets with well-defined edges showing hexagonal symmetry. The platelet thicknesses were less than 1 μm and their diameters ranged from about 5-50 μm.

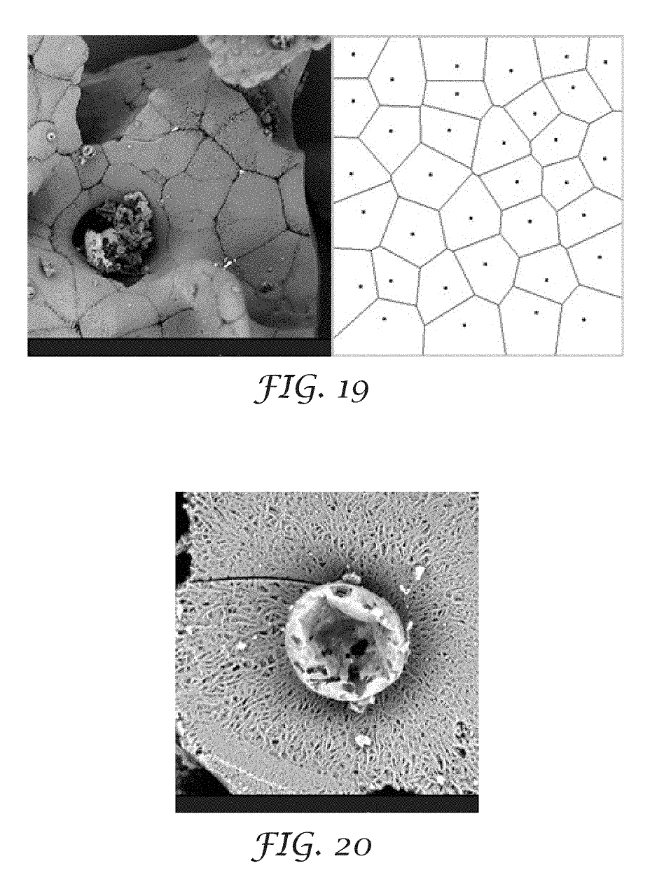

Examples 1-5 exhibited tessellated regions, which is characteristic of a crystallization process via nucleation and growth from a central seed, as illustrated in FIG. 19. In all examples where tessellations were observed, a central seed was also observed. The central seeds are located at the particle surface near the centroid of the tessellated regions. This central seed often had the form of a graphite sphere or sphere fragment that in some cases also contained graphite platelets, as shown in FIG. 20.

Within each tessellation, graphite fibers or sheets are seen to radiate outward from the central seed, as shown in FIG. 20. Example 3, in which the XRD pattern showed a similar amount of graphite phase and amorphous carbon phase, was a partially tessellated graphite, in which the tessellated phase was graphitized and the amorphous carbon phase was not, as shown in FIG. 8. This demonstrates that the growth of the tessellations was radial from the seed particles. The size of the tessellated regions varied from about 10-100 μm (microns).

Table 3 summarizes observations by SEM. All examples comprised decorated graphitic spherical shells and decorated graphitic spherical shell fragments. In all samples the minimum size of platelets and graphite spherical shells could not be detected. The thickness of all graphite platelets observed was less than 500 nm. Free graphite platelets and graphite platelets that were randomly packed were observed in all samples.

TABLE 3
Summary of SEM Analysis

| | Maximum | | relative | | | | | |
|---|---|---|---|---|---|---|---|---|
| | diameter of | | amount of | | | relative | relative | relative |
| | decorated | | sample in | Maximum | | amount of | amount of | amount of |
| | graphite | | form of | diameter of | | sample in | sample in | sample in |
| | spherical | | decorated | graphite | | form of | tessellated | form of |
| Example | shells | | shells | platelets | | platelets | regions | PREA** |
| 1A | 50 | μm | 1% | 50 | μm | 2% | 10% | 1% |
| 1 | 20 | μm | 1% | 7 | μm | 10% | 99% * | 1% |
| 2 | 50 | μm | 10% | 20 | μm | 12% | 88% * | 10% |
| 3 | 50 | μm | 10% | 3 | μm | 10% | 80% * | 10% |
| 4 | 50 | μm | 9% | 5 | μm | 10% | 90% * | 10% |
| 5 | 100 | μm | 1% | 25 | μm | 2% | 98% * | 2% |
| 6 | 100 | μm | 1% | 20 | μm | 2% | 0% | 2% |
| 7 | NA | | 0% | 3 | μm | 80% | 0% | 80% |
| 8 | NA | | 0% | 10 | μm | 50% | 0% | 50% |
| 9 | 60 | μm | 60% | 20 | μm | 60% | 0% | 60% |
| 10 | 60 | μm | 90% | 30 | μm | 90% | 0% | 60% |
| 11 | 40 | μm | 10% | 20 | μm | 15% | 0% | 15% |

| | | | | | | | |
|---|---|---|---|---|---|---|---|
| 12 | NA | 0% | 15 | μm | 100% | 0% | 100% |
| 13 | NA | 0% | 4 | μm | 80% | 0% | 80% |

* fully tessellated
**PREA = perpendicular random edge arrays

### Sample Composition and Purity

Sample composition was investigated by XRD and EDS measurements. For all of the examples, except Example 8, no peaks were detected in XRD patterns other than those that could be attributed to graphite or amorphous carbon and all elements except carbon were below the detection limits of the EDS measurements. FIG. 3, as an example, shows an XRD pattern for Example 12, for which only graphite or amorphous carbon phases could be detected, and demonstrates that the graphite of the present disclosure can be made to such high purity that the impurities are not detectable by means of XRD. These results indicate that all examples, except Example 8, were free of impurities to the extent that their chemical composition comprised at least 98 atomic % carbon. In the case of Example 8, as shown in FIG. 4, peaks in the XRD patterns indicated the presence of MgO.

The densities of the examples were measured as a check for purity. Graphitic carbon has a known density of 2.26 g/ml. Carbons that are disordered have densities that are lower than this. Sample densities higher than 2.26 g/ml indicate the presence of phases having a higher density than graphite. Therefore excess density above 2.26 g/ml was interpreted as a measure of impurity content.

MgO is a phase having a higher density than graphite (the density of MgO is 3.58 g/ml) and therefore its presence would tend to cause the sample density to be higher than graphite. Since MgO is the most likely impurity and was detected in Example 8 by XRD, sample densities higher than 2.26 g/ml were used to estimate the atomic percent MgO in the sample, by assuming the sample contained only MgO with a density of 3.58 g/ml and carbon with a density of 2.26 g/ml. By assuming the sample only contained MgO and carbon, the weight % Mg in the samples was then estimated.

TABLE 4
Sample Composition

| | | Estimated MgO | Estimated Mg |
|---|---|---|---|
| Exam- | Density | Content | Content |
| ple | (g/ml) | (atomic %) | (weight %) |
| 1A | 1.8245 | NA | NA |
| 1 | 2.1932 | NA | NA |
| 2 | 2.2790 | 0.68 | 1.36 |
| 4 | 2.2735 | 0.49 | 0.97 |
| 6 | 2.2613 | 0.04 | 0.09 |
| 7 | 2.2941 | 1.24 | 2.43 |
| 8 | 2.6819 | 18.15 | 25.7 |
| 9 | 2.2756 | 0.56 | 1.12 |
| 10 | 2.1137 | NA | NA |

Except Example 8, all examples for which the density was measured had densities less than 2.28 g/ml. This suggests an MgO impurity content of less than 1.25 atomic % or 2.44 weight %. This further suggests that all examples for which the density was measured, except Example 8, comprise carbon in an amount that is greater than 98 atomic % or 97 weight %.

### Electrochemical Results

Examples evaluated in electrochemical Li cells demonstrated reversible cycling with reversible capacities ranging from 180 to 341 mAh/g and showed peaks in their differential capacity curves characteristic of an ordered graphite, except for Example 1A. Examples 7, 9, 10 and 13 showed extremely well defined peaks in their differential capacity curves, characteristic of a highly ordered graphite.

All examples that were evaluated in electrochemical Li cells retained about 94.03%˜99.40% of their initial capacity after 50 cycles, except Example 13, which retained 95.11% after 40 cycles.

TABLE 5
Cycling results for Li electrochemical cells

| Exam- | cycle 2 | capacity retention |
|---|---|---|
| ple | capacity | after 50 cycles |
| 1A | 178 mAh/g | 94.03% |
| 1 | 189 mAh/g | 97.14% |
| 2 | 210 mAh/g | 96.51% |
| 3 | 234 mAh/g | 96.90% |
| 4 | 195 mAh/g | 95.55% |
| 5 | 242 mAh/g | 95.83% |
| 6 | 293 mAh/g | 99.35% |
| 7 | 341 mAh/g | 99.12% |
| 8 | 250 mAh/g | 98.80% |
| 9 | 264 mAh/g | 99.40% |
| 10 | 284 mAh/g | 99.45% |
| 13 | 323 mAh/g | 95.11% (40 cycles) |

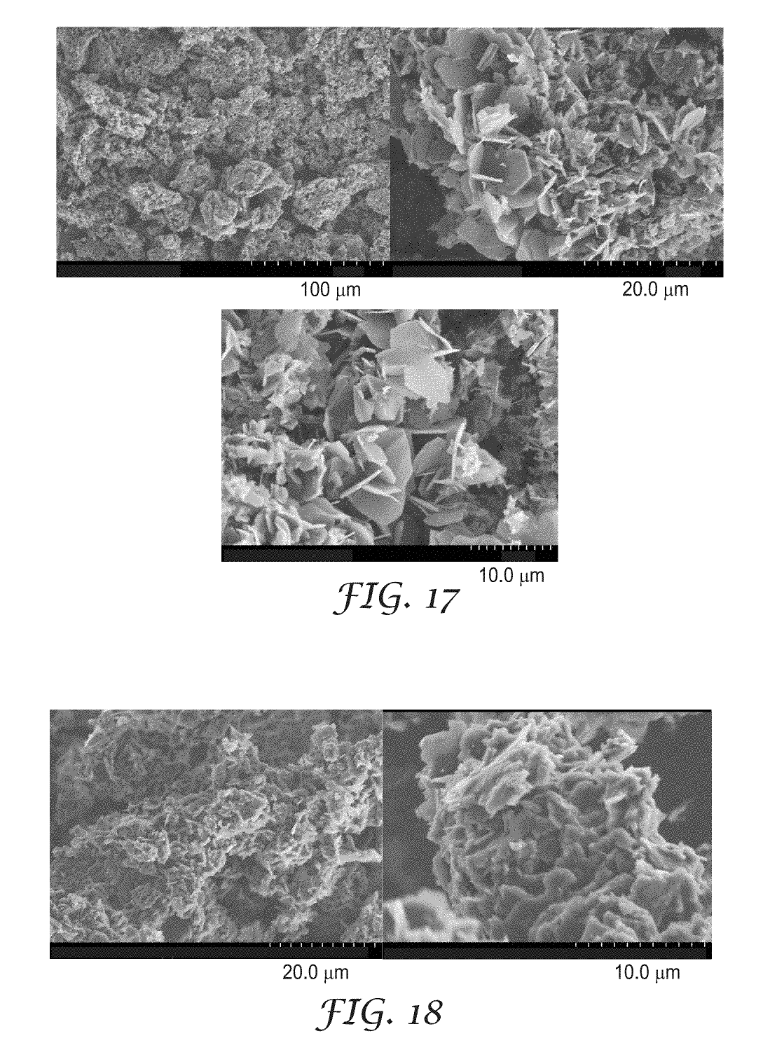

Example 7 and 13 were prepared in the same way, except that Example 13 was carbon coated. Graphite platelets were still visible in Example 13 by SEM after the carbon coating process, as shown in FIG. 18. Carbon coating was found to reduce the first lithiation capacity substantially, thereby reducing the irreversible capacity and increasing the initial coulombic efficiency (ICE, ratio of 1st delithiation capacity to 1st lithiation capacity) as shown in Table 6.

TABLE 6
Cycling results for Li electrochemical cells

| Exam- | 1st lithiation | 1st delithiation | irreversible | ICE |
|---|---|---|---|---|
| ple | capacity | capacity | capacity | (%) |
| 7 | 843 mAh/g | 341 mAh/g | 502 mAh/g | 40 |
| 13 | 448 mAh/g | 323 mAh/g | 125 mAh/g | 72 |

Although specific embodiments have been illustrated and described herein for purposes of description of some embodiments, it will be appreciated by those of ordinary skill in the art that a wide variety of alternate and/or equivalent implementations may be substituted for the specific embodiments shown and described without departing from the scope of the present disclosure.

What is claimed:

1. A graphitic carbon material comprising:
decorated graphitic spherical shells or fragments of decorated graphitic spherical shells, wherein the decorated graphitic spherical shells or fragments of decorated graphitic spherical shells have an average diameter of between 0.1 and 100 μm.

2. The graphitic carbon material of claim 1, wherein any decorated graphitic spherical shells or fragments of graphitic spherical shells, collectively, are present in the graphitic carbon material in an amount of between 40 and 100 vol. %, based on the total volume of the graphitic carbon material.

3. A graphitic carbon material comprising:
tessellated regions, wherein the tessellated regions are present in the graphitic carbon material in an amount of between 5 and 100 vol. %, based on the total volume of the graphitic carbon material.

4. The graphitic carbon material of claim 3, wherein the graphitic carbon material is in the form of particles, and wherein the particles comprise tessellated regions and non-tessellated regions.

5. The graphitic carbon material of claim 4, wherein the tessellated regions are present in the particles in an amount of between 5 and 100 vol. %, based on the total volume of the particles.

6. The graphitic carbon material according claim 4, wherein the non-tessellated regions are present in the particles in an amount of between 1 and 95 vol. %, based on the total volume of the particles.

7. The graphitic carbon material according to claim 4, wherein the non-tessellated regions comprise amorphous carbon.

8. The graphitic carbon material according to claim 4, wherein the tessellated regions have an average diameter of between 10 and 200 μm.

9. The graphitic carbon material according to claim 1, wherein graphite is present in the graphitic carbon material in an amount of between 50 and 100%, based on total volume of the graphic carbon material.

10. The graphitic carbon material according to claim 1, wherein the graphitic carbon materials comprise either or both of the 2H graphite phase and the 3R graphite phase.

11. The graphitic carbon material according to claim 1, wherein the graphitic carbon materials have a BET surface area of between 30 and 500 m²/g.

12. The graphitic carbon material according to claim 1, wherein the graphitic carbon material contains less than 1 atomic % of Fe, Al, Si or Ca.

13. The graphitic carbon material according to claim 1, wherein the graphitic carbon material comprises graphite in an amount of greater than 85 atomic %, based on the total number of carbon atoms present in the graphitic carbon material, and the graphitic carbon material has density as measured by helium pycnometry of between 2.25 g/ml and 2.28 g/ml.

14. The graphitic carbon material according to claim 1, wherein the graphitic carbon material comprises carbon in an amount that is greater than 98 atomic %, based on the total number of atoms in the graphitic carbon material.

15. An electrode comprising:
an electrode composition comprising the graphitic carbon material according to claim 1; and
a current collector.

16. An electrochemical cell comprising:
the electrode of claim 15.

17. The electrochemical cell of claim 16, wherein the electrochemical cell comprises a lithium ion electrochemical cell, and wherein the electrode comprises a negative electrode.

18. The electrochemical cell of claim 17, further comprising a positive electrode and an electrolyte.

19. An electronic device comprising the electrochemical cell according to claim 1.

20. A method of making a graphitic carbon material, the method comprising:
combining a carbon source and magnesium to form a mixture;
triturating the mixture;
heating the mixture in an inert atmosphere; and
following the step of triturating the mixture or heating the mixture in an inert atmosphere, removing the non-carbon containing components from the mixture.
